(19) United States
(12) Patent Application Publication
(10) Pub. No.: US 2009/0238045 A1
(43) Pub. Date: Sep. 24, 2009

(54) AC'S WRISTWATCH EZ-WEAR PROTECTIVE CLIP-ON/COVER

(76) Inventor: Arthur Felton, Virginia Beach, VA (US)

Correspondence Address: DUNCAN G. BYERS PC, 142 W. York Street, Suite 910, NORFOLK, VA, 23510, US

(21) Appl. No.: 12/409,260

(22) Filed: Mar. 23, 2009

Related U.S. Application Data
(60) Provisional application No. 61/038,609, filed on Mar. 21, 2008.

(51) Int. Cl. G04B 37/14

(52) U.S. Cl. 368/282

(57) ABSTRACT

A protective device for watchband straps. The protective device is comprised of a curved semi-rigid material with retention means for affixing the protective device to hinge portions of watchbands. The protective device eliminates wear on the watchband at the fastener. The protective device may further be utilized to protect the underside of a wristwatch.

### This application claims the benefit of Provisional Application No. 61/038,609, filed Mar. 21, 2008.

### FIELD OF INVENTION

The present invention relates to a protective device used for the clasps and/or fasteners of wristwatches.

### DESCRIPTION OF PRIOR ART

Wristwatches are widely used in modern society to provide the basic function of alerting the wearer as to the time. Similar to preferences in clothing and fashion trends, wristwatches may reflect style preferences of the wearer, may require a significant financial investment, or may hold great sentimental value to the owner. As such, many protective devices in the prior art seek to prevent the loss and/or damage of wristwatches. Intrinsic to many wristwatches are the wristbands or straps securing the wristwatch to a user's arm. Bands may, in and of themselves, have significant monetary or other value. However, due to the nature of a wristwatch and how it is worn, wristwatch bands are subject to wear and tear, even if the user is careful.

While the prior art addresses the issue of protecting the time piece and its components, and, in many instances, the wristwatch and wrist band as a whole, it has overlooked the issue of protecting the clasp portion of many wristwatch bands. While flexible bands made of leather, fabric, and the like generally utilize buckles to secure the ends of a band, metal and other solid material wristwatch bands require other types of fastening mechanisms. During normal wear, opposing surfaces of a clasping mechanism come into contact with each other, causing wear to even the most resilient of materials. This is especially undesirable in bands that are constructed of or plated with softer materials, such as gold.

Various types of mechanisms exist for connecting and fastening together the ends of wristwatch bands constructed of metals and the like. The present invention is intended for use with the widely used watch clasp construction that generally employs a U-shaped frame member, clamping lever, and clasp cover, as illustrated at FIG. 1, Iirzuki U.S. Pat. No. 3,636,596 (Jan. 25, 1972).

Once the fastening mechanism of a wristwatch is locked into its closed position, the opposing surfaces of the clasp construction members grate against each other causing wear and tear. As noted, however, there is no prior art that provides a means by which to minimize and/or preclude wear and tear borne by the locking clasp constructions of the prior art. The present invention, namely, a protective device that is inserted between clasp members and fixedly attached to the watch band prevents the members from coming into contact with each other, thereby preventing wear and tear due to friction. The present invention provides an additional benefit in that dirt, dust, grime, and other particles that may otherwise infiltrate the chamber area of the clasping construction are prevented from being deposited within that portion of the clasping construction, avoiding additional wear and tear that may be caused by the accumulation of such particles.

### SUMMARY OF THE INVENTION

It is desirable to have a protective device which functions to prevent the wear and tear of the clasping plates and of any other portion of the wristwatch that results from regular use. The present invention is intended to protect the band of a wristwatch at the portion of the band where the clasping plates are pressed together in their closed, locked position. The present invention may be constructed of a variety of materials, including plastics, metals, and rubbers. Materials that do not cause wear when in contact with harder metals are preferred, and in a preferred embodiment the protective device is constructed of plastic.

It is therefore an object of the present invention to provide a protective device in the form of a protective clip, that will prevent the wear and tear of watch band clasping plate components, and of any other portion of the wristwatch to which the protective device may be secured, that results from regular use and subsequent rubbing of portions of a wristwatch band when the clasping plate members are pressed together in their closed, locked position.

It is another object of the present invention to remain in position within the clasping construction of a wristwatch band that does not disfigure or otherwise harm the wristwatch band with securing adhesives or the like.

It is another object of the present invention to extend the useful life of the clasping construction of a wristwatch band.

It is another object of the present invention to provide a lightweight, protective clip or insert having a simplistic design which may be economically manufactured and used with a variety of types of wristwatch bands.

It is another object of the present invention to provide a protective device that may be easily inserted and easily removed by the wearer from the clasping construction.

It is another object of the present invention to provide a protective device that reduces or obviates the need to replace watch band clasping parts.

### DESCRIPTION OF THE DRAWINGS

FIG. 1 is a perspective view of the protective clip.

FIG. 2 is a perspective view of the protective clip as it is intended to be affixed onto the clasping construction of a wristwatch.

FIG. 3 shows another embodiment of the present invention.

FIG. 4 shows yet another embodiment of the present invention.

### DESCRIPTION OF THE PREFERRED EMBODIMENTS

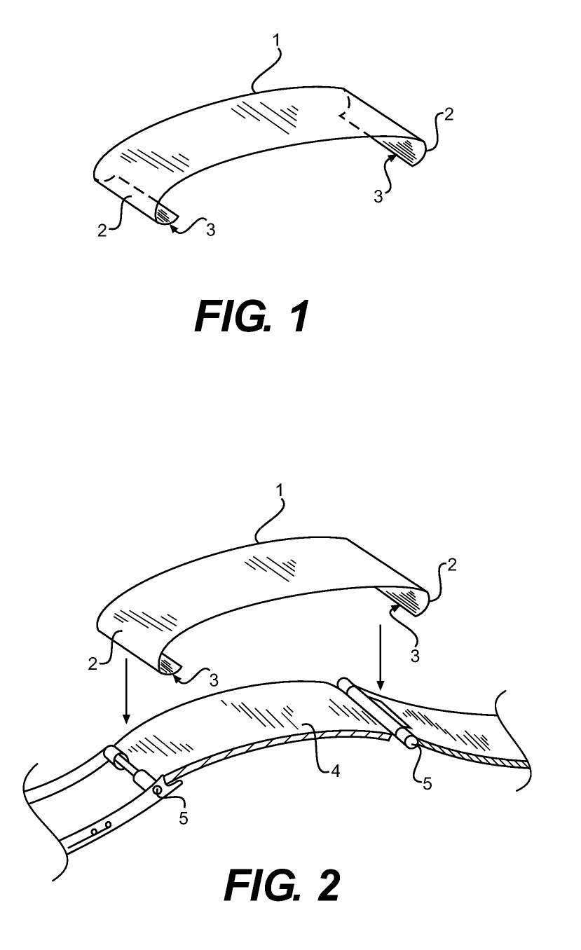

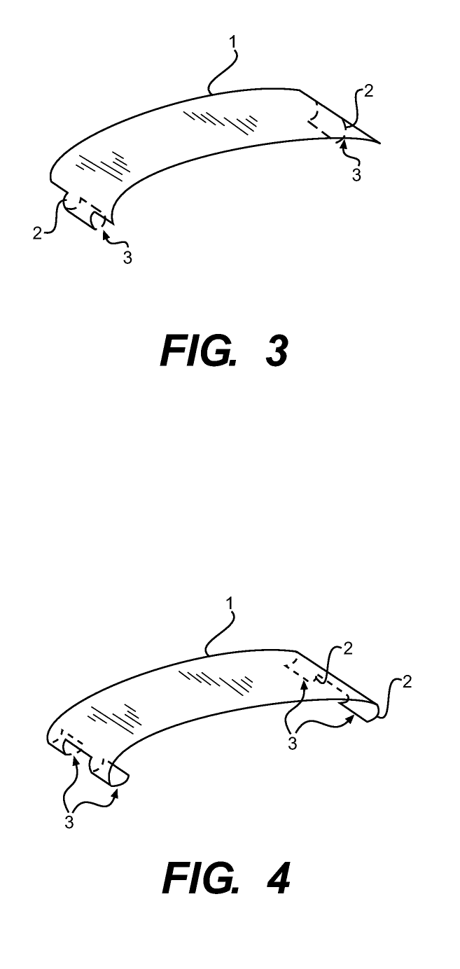

In accordance with the invention, FIG. 1 illustrates a preferred embodiment of the invention, namely a protective clip that may be constructed of plastic, metal, synthetic, natural, or other suitable material that is semi-rigid, and that is manufactured in shapes to accommodate use with the clasping constructions used for wristwatches, which typically are comprised of (1) a U-shaped frame member, which includes a base plate and upright longitudinal side walls that form a channel area for securing the ends of the watch band/strap; (2) a clamping plate positioned, in most instances, along one end of the watch band and placed just inside the channel area of the frame member bearing downwardly against the base plate in its closed position; and (3) a clamping lever, positioned adjacent to the clamping plate, and which also may function as a clasp cover or cap. Referring to FIG. 1, the protective clip is one solid piece that comprises a body 1, two (2) projecting end portions 2 that are generally U-shaped, forming channels 3 that are horizontally situated with relation to the body 1 of the protective clip. Each channel 3 may extend the width of the body 1, or may be of a shorter width as shown in FIG. 3. It will be further understood that the channels 3 may each comprise one or more generally U-shaped portions, as shown in FIG. 4.

The body 1 of the protective clip is generally planar, and may further comprise a curvature along the long axis of the clip, that curvature the same as the curvature of the locking portions of a watch band in such a manner as to fit firmly between members of the clasping construction. In another embodiment, the invention illustrated in FIG. 1 may also be sized for affixation along the underside of the timepiece portion of the wristwatch wherein the protective clip is situated between the back portion of a watch and a watch band or the wearer's wrist, thereby preventing wear on the back portion of a watch.

As illustrated in FIG. 2, the protective clip is intended to be affixed to a generally planar surface of a member of the clasping construction of a wristwatch band. Said affixation may involve placing the protective clip at any point along the watch that is amenable to affixation of the clip, preferentially, between any two members of the clasping construction. As further shown in FIG. 2, the protective clip is secured onto the clasping member 4 by way of the channels 3 formed by the end portions 2, fitting the channels 3 around the hinge portions 5 of the clasping member 4. The device may additionally be held in place between two opposing surfaces, preferentially between the opposing surfaces of two clasping members.

Referring now to FIG. 3, an embodiment of the present invention is shown wherein the end portions 2 form channels 3 wherein the channels 3 are less than the width of the body 1 of the clip. Such a configuration allows the present invention to be utilized in watch bands of varying widths and designs. In a preferred embodiment, the present invention is of a matching width to the width of the watch band to which it is to be affixed, and the channels 3 formed by the end portions 2 are also sized to fit snugly onto a particular size and design of watch band.

FIG. 4, referred to above, illustrates an embodiment of the present invention comprising a plurality of individual channels 3 at each end portion 2.

Removal by the wearer may be accomplished by releasing the clasp cover from its closed position.

The invention has been described in detail with particular reference to the preferred embodiment thereof, but it is understood that modifications and variations of the invention can be made without deviating from the spirit and scope of the invention.

What is claimed is:

1. A wristwatch band protective device, comprising:
a center portion;
a first end portion; and
a second end portion.

2. The wristwatch band protective device of claim 1, wherein said center portion is curved such that the center portion fits within the clasp portion of a wristwatch band.

3. The wristwatch band protective device of claim 1, wherein said first end portion and said second end portion further comprise fastening means.

4. The wristwatch band protective device of claim 3, wherein said fastening means comprises protruding curved portions forming channels to receive hinge portions of a wristwatch band.

5. The wristwatch band protective device of claim 1, wherein said wristwatch band protective device is comprised of metal.

6. The wristwatch band protective device of claim 1, wherein said wristwatch band protective device is comprised of a synthetic material.

7. The wristwatch band protective device of claim 1 wherein said wristwatch band protective device is comprised of a natural material.
